(19) United States
(12) Patent Application Publication
(10) Pub. No.: US 2007/0143830 A1
(43) Pub. Date: Jun. 21, 2007

(54) Method, apparatus and system for preventing unauthorized access to password-protected system

(75) Inventors: Subil M. Abraham, Plano, TX (US); Tam M. Cao, Trophy Club, TX (US); Subramanian Raman, Overland Park, KS (US); Tassanee Supakkul, Euless, TX (US); Mathews Thomas, Flower Mound, TX (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 11/312,092

(22) Filed: Dec. 20, 2005

(51) Int. Cl. H04L 9/32

(52) U.S. Cl. 726/5

(57) ABSTRACT

A method, apparatus and system are provided for preventing unauthorized access to a password-protected system by authenticating a user over a communication medium. Authentication of a user is accomplished by sending to the user, via a communication medium, an instruction that includes at least one element in which the user is directed to provide input that is not alphanumeric. Examples of such elements include, but are not limited to, a directive that the user place an object in a specific position on a display screen or that the user touch a specific location on a touch screen display. Once the user replies to the instruction over the communication medium with the requested input, an authentication server receives the input and checks it to determine whether the input complies with the issued instruction. If the results of the server determination are sufficient, and if the authentication server also has sufficient identifying information regarding the user, an indication is sent to the user via the communication medium that the user is authenticated.

### FIELD OF THE INVENTION

This invention relates generally to user authentication techniques, and in particular relates to a method and apparatus for authenticating a user prior to allowing the user to access a secure system, such as one protected by password, using input submitted by the user that is in response to an instruction issued by or on behalf of the secure system.

### BACKGROUND OF THE INVENTION

Computer systems often employ computer security techniques, such as access control mechanisms, to prevent unauthorized users from accessing certain information, such as sensitive or personal information contained in a database on the system. The process of verifying the identity of a user in a computer system as having access to such information is often termed user authentication. There are a number of different protocols for user authentication to prevent the unauthorized access of information. One common protocol involves the use of a password that must be asserted along with a user's identity, e.g., a username. In such a password-protected system, each user has a password which the user must provide to the system, along with his or her identity (i.e., username), to prove his or her authority to access the system and the information contained therein. A central data processing unit for the system then compares the password provided by the user with the stored password corresponding to that particular user, and if the text matches, the user is authorized to access the system.

Concerns regarding the security of electronic communications and computer systems are rising inversely with the failure of password protection protocols to prevent unauthorized access to sensitive information. In password protected systems, individuals without access to a particular secured system who are intent upon gaining such access have been able to gain authentication as a user by, for example, using computer programs to submit many combinations of usernames and passwords to the system until the correct combination is found, literally by trial and error. Not only does this result in a breach in security, but the submissions of multitudes of computer-generated guesses at username/password combinations can also severely impact the performance of the computer system, especially if multiple password deciphering programs concurrently hit a given system.

Therefore, a simple password protocol often does not provide adequate security for sensitive information, since a password that is selected by a user might be easy for an attacker to guess. Some ways in which the security offered by simple password protocol is bolstered include: limiting the number of logon attempts (to prevent an attacker from trying combinations to guess a password) and requiring an authorized user to correctly answer personal information, such as mother's maiden name or social security number. The former can be problematic in that a user who has authority to access the information, but for whatever reason has difficulty entering his or her username and password correctly, will likely be disabled from further logon attempts and will be required to seek a password reset, which can be expensive to administer across an information technology system, e.g., including resources for first disabling the account then resetting the password and sending the new password to the authorized user. The latter can be problematic in that the questions posed are often generic and/or easily gathered from other sources, so that the response to the questions can often be determined programmatically or via a second more public source of information.

Another method for defeating attempts at unauthorized access into a password protected system is providing a distorted image of a word or number and asking the individual seeking access to enter that word or number, such as via typing on a keyboard. However, recent developments in computer vision have made it possible to programmatically decipher these images.

Therefore, a need remains to prevent unauthorized access of information stored in computer systems, such as by the use of sophisticated programs that try multiple username/password combinations and/or that programmatically decipher, and then submit for access, authenticating images set forth in the user authentication process.

### SUMMARY OF THE INVENTION

The need of the prior art for preventing unauthorized access to secure systems is addressed by the present invention. In accordance with the invention, disclosed is a method for authenticating a user over a communication medium, the method comprising the steps of sending, via a communication medium, an instruction to the user that includes at least one element in which the user is directed to provide input that is not alphanumeric; in response to the instruction, the user preparing the instructed input and sending it via the communication medium; an authentication means receiving the input via the communication medium and checking it to determine whether it complies with the instruction; and, if results of the authentication means are sufficient, and the authentication means has sufficient identifying information regarding the user, sending via the communication medium an indication that the user is authenticated.

Also claimed is a computer program product capable of performing steps for authenticating a user over a communication medium, those steps comprising sending via a communication medium an instruction to the user that includes at least one element in which the user is directed to provide input that is not alphanumeric; receiving the input from the user via said communication medium; checking the input to determine whether it complies with the instruction; and, if results of said determination are sufficient, and with sufficient identifying information regarding the user, sending via the communication medium an indication that the user is authenticated.

Also claimed is a system for authenticating a user over a communication medium. The recited system comprises a first transmitter means to send via the communication medium an instruction to the user that includes at least one element in which the user is directed to provide input that is not alphanumeric; an authentication means to receive the input via the communication medium, to check it to determine whether it complies with the instruction, and to check for the sufficiency of identifying information regarding the user; and a second transmitter means to send to the user, via the communication medium, an indication regarding whether user is authenticated.

Also claimed is a method for providing the service of authenticating a user over a communication medium for access to a secure system. The recited method involves sending, via a communication medium, an instruction on behalf of the secure system to a user that includes at least one element in which the user is directed to provide input that is not alphanumeric; receiving user input in response to the instruction via the communication medium and checking the input to determine whether it complies with the instruction; and, if the user input is sufficient, sending via the communication medium an indication that the user input is sufficient.

For a fuller understanding of the present invention, reference should be made to the following detailed description taken in conjunction with the accompanying drawings.

### BRIEF DESCRIPTION OF THE DRAWINGS

The novel features believed characteristic of the invention are set forth in the appended claims. The invention itself, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 is a flowchart illustrating a procedure, in accordance with one embodiment of the present invention, by which an authorized user secures the authorization to make additional logon attempts;

FIG. 3 is a flowchart illustrating a procedure, in another embodiment of the present invention, by which an authorized user authenticates his or her identity to access a secure system;

FIG. 4 is a graphical illustration that depicts a typical display that may be set forth via a graphical user interface to allow a user to input a user identification and password to initiate an authentication process for access to a secure system, as may be used within a data processing system in which the present invention may be implemented;

FIG. 5A is a graphical illustration that depicts an example of a display that may be set forth via a graphical user interface, in accordance with one embodiment of the present invention, to authenticate a user for access to a secure system;

FIG. 5B is a graphical illustration that depicts an example of a display that may be set forth via a graphical user interface, in accordance with another embodiment of the present invention, to authenticate a user for access to a secure system;

FIG. 5C is a graphical illustration that depicts an example of a display that may be set forth via a graphical user interface, in accordance with another embodiment of the present invention, to authenticate a user for access to a secure system; and

FIG. 6 is a flow chart indicating steps taken in one embodiment of the invention for providing a service of authenticating a user over a communication medium for access to a secure system.

### DETAILED DESCRIPTION OF THE INVENTION

This invention is described in preferred embodiments in the following description with reference to the Figures, in which like numerals represent the same or similar elements. While this invention is described in terms of the best mode for achieving this invention's objectives, it will be appreciated by those skilled in the art that it is intended to cover alternatives, modifications, and equivalents as may be included within the spirit and scope of the invention as defined by the appended claims.

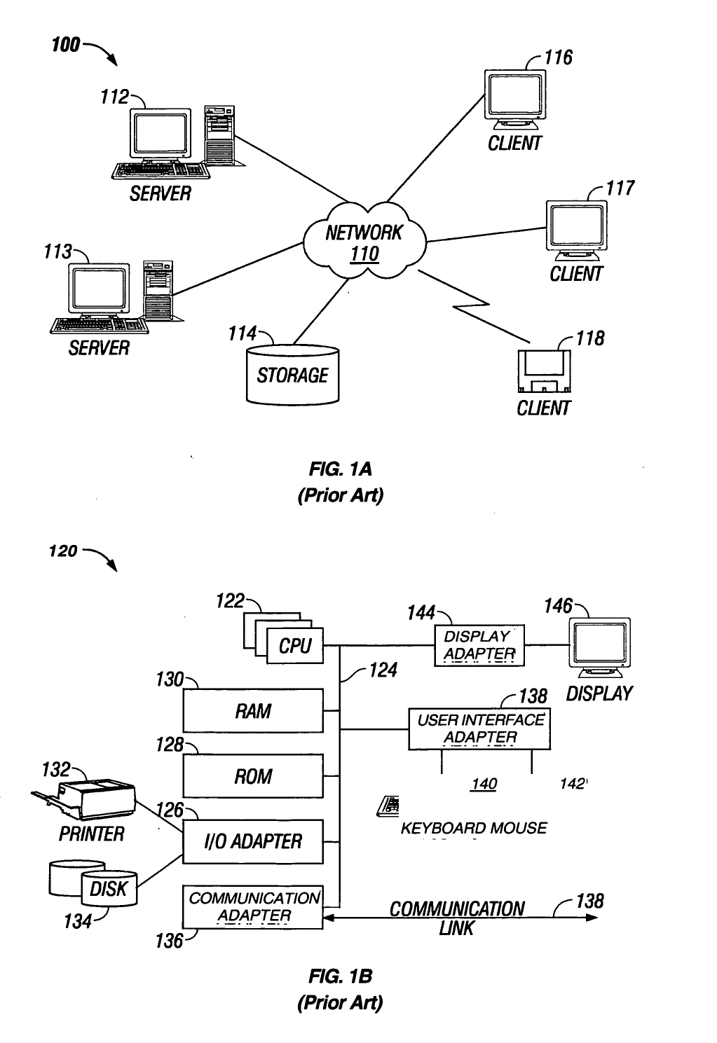

With reference now to the Figures, FIG. 1A depicts a typical data processing system network. Each of the data processing systems shown in FIG. 1A may implement the present invention. Distributed data processing system 100 contains network 110, which provides communications links between various devices connected together within the distributed data processing system 100. Network 110 may employ any type of communication link that allows for the transmittal of data between the various devices in the system 100, including but not limited to wire, fiber optic cables, or telephone or wireless communications systems. In the example depicted in FIG. 1A, servers 112, 113 are connected to network 110 along with storage unit 114. In addition, clients 116-118 also are connected to network 110. Clients 116-118 and servers 112,113 may be represented by a variety of computing devices, such as mainframes, personal computers, etc., and are not limited to any particular type of such device. For example, a client 116-118 can be any device that is capable of receiving communications over the network 110 and, in turn, capable of sending communications to, e.g., servers 112,113 over the network 110, including a personal computer, a cell phone, a personal display device (PDA) or other such handheld devices. Distributed data processing system 100 may include additional servers, clients, routers and other devices not shown. In the depicted example, distributed data processing system 100 may include the Internet with network 110 representing a worldwide collection of networks and gateways that use the TCP/IP suite of protocols to communicate with one another. Distributed data processing system 100 may also include a number of different types of wired or wireless networks, such as, for example, an intranet, a local area network (LAN), a wide area network (WAN), or the Public Switched Telephone Network (PSTN).

The present invention could be implemented on a variety of hardware platforms. FIG. 1A is intended as an example of a heterogeneous computing environment and not as an architectural limitation for the present invention. The distributed data processing system 100 is merely exemplary of the sort of system 100 that includes devices that are used in the practice of the invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 124, which interconnects input/ouput adapter 126, read-only memory 128, and random access memory (RAM) 130. The input/output adapter 126 may support various I/O devices, such as printer 132, disk units 134, or other devices not shown, such as a sound system, etc. Internal system bus 124 also connects the communication adapter 136 that provides access to communication link 138. User interface adapter 138 connects various user devices, such as keyboard 140 and mouse 142, or other devices not shown, such as a touch screen, stylus, etc. Display adapter 144 connects system bus 124 to display device 146. The data processing system 120 depicted in FIG. 1B might depict, for example, the structure of the system that functions as client 116.

In operation, a user employing a user device, such as keyboard 140 or mouse 142, sends a message over a network 110 (using communication link,138) to another device attached to the network 110, such as server 112. The server 112 may in turn be associated, for example with a call center or web server. As already noted, the server 112 may be any computing device, such as a personal computer, workstation or the like.

Those of ordinary skill in the art will appreciate that the hardware in FIG. 1B may vary depending on the system implementation. For example, the system may have one or more processors, and other peripheral devices may be used in addition to or in place of the hardware depicted in FIG. 1B. The depicted examples are not meant to imply architectural limitations with respect to the present invention. In addition to being able to be implemented on a variety of hardware platforms, the present invention may be implemented in a variety of software environments. A typical operating system may be used to control program execution within the data processing system.

In the practice of the invention, a device within the distributed data processing system 100, such as server 112, serves as an authentication device or authentication server. The authentication device 112 serves to process requests for access to a secure system or database (not shown) from other devices in the network 100, such as but not limited to clients 116-118. In a typical system, a client 116 submits an identification string (such as a “user id” along with a password) over network 110 to the authentication device 112, which then checks the information using a CPU 122 against information contained on, e.g., a disk 134, to determine whether the information matches such that the client 116 should be granted access to the secure system. If the information provided by client 116 is sufficient, the client 116 will be informed of, and given, access to the secure system. If the information provided by client 116 is not sufficient or matching, the client 116 will typically be so informed and will be denied access to the secure system. It is noted that the invention is not limited to the foregoing authentication system, i.e., the use of a user id and password, but is rather contemplated to augment any system of user authentication through submission by the user of identifying information.

The authentication device 112 can be any device capable of authenticating a user, and could be as simple as a computer with software installed that is capable of storing all of the user identification strings for authorized users and, upon receipt of a request to access the secure system, checking such request against that information to determine whether access to the system should be granted. A large secure system would likely employ an authentication server 112 dedicated to the task of authenticating users.

Typically, in regard to a password protected system, a client 116 is permitted to attempt to request access to the secure system or database some specific number of times, e.g., “N” times, where “N” is set by the system administrator for the authentication process. A primary reason for limiting attempts to “N” times is in recognition of the possibility that the user is actually a computing device, as opposed to a human being, that is programmatically generating user Ids and passwords in an attempt to gain access, albeit improperly, to the secure system or database by guessing the user id and password. Typically, such programmatically generated attempts have certain patterns whereby the guesses derive from a dictionary or the like, and successive attempts to log on to the secure system are variations of the immediately preceding attempt.

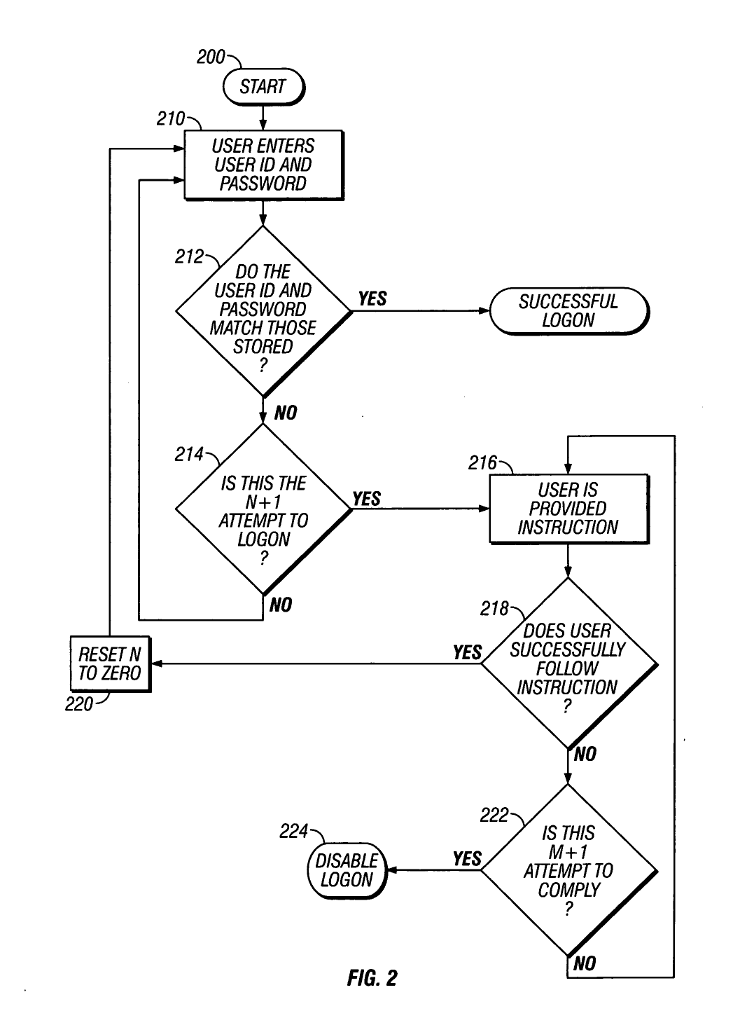

Turning to FIG. 2, a flowchart is presented that depicts an exemplary process in the practice of the invention. At Step 200, the user starts the authentication process. At Step 210, the user (e.g., using the device client 116) enters a user id and password and submits the same over a communication link 138 to authentication server 112. At Step 212, the authentication server 112 determines whether the user ID and password match those stored on the system, and if so and the information is sufficient, the authentication server allows the user access to the secure system. However, if the authentication server 112 determines that the user ID and password do not match those stored on the system and the information is therefore insufficient to authentication, the authentication server 112 will not allow the user access to the secure system but will determine, in Step 214, whether to allow the user to make another attempt to submit a user ID and password. If the user has not yet made at least N unsuccessful attempts, the authentication server 112 will allow the user to attempt to re-submit a user ID and password at Step 210. However, if the user has made N+1 attempts, the user will not be allowed to make another attempt at Step 210 but is instead presented with a challenge in Step 216.

In Step 216, and in accordance with the present invention, the user is presented with an instruction. The instruction will require the user to submit input, at least one element of which is not alphanumeric. Examples of non-alphanumeric input include, but are not limited to, requiring the user to manipulate a mouse 142 or a stylus or the like in some prescribed fashion; to type non-alphanumeric information at a keyboard 140; or to touch a touch screen display at a prescribed location. Since the input required of the user of not alphanumeric, this step is useful in deterring improper logon by a programmatic dictionary attack. The instruction presented to the user in Step 216 is contemplated to be generated by a program running on the authentication server 112, or some computing device to which the authentication server 112 is linked. The display of the instruction on the screen 146 and the receipt and communication of user responses to the instruction can be accomplished by an applet running, for example, on the browser employed by the client 116 to navigate the network 110. The display of the instruction and the handling of user responses, or even the entire logon process, can be accomplished by the login window invoking a service to accomplish the same. The practice of the invention is not contemplated to be limited to any particular means of displaying the instruction or handling user responses to the instruction.

An example of an instruction to manipulate a mouse 142 that might be employed in the practice of the invention includes, but is not limited to, presenting the user with an object that moves on the display screen 146 and requiring the user to track the movement of the object with a mouse 142. Another example includes presenting the user with a series of random dots and requiring the user to connect the dots while the dots change position, such as by selecting, with the mouse 142, the area of the screen 146 that connects two series of dots. Another example includes presenting the user with an object on the screen 146 and instructing the user to move the object to some particular area on the screen 146, such as by selecting the object with a mouse 142, “dragging” the object (as is known in the art of manipulation of a mouse) to the target destination, and releasing the object at that destination. As one skilled in the art would recognize, the invention is not limited by the type of instruction presented by the user to be accomplished with a mouse or stylus or the like, so long as the input to be provided by the mouse or stylus or the like is not alphanumeric.

An example of an instruction to type non-alphanumeric information at a keyboard 140 that might be employed in the practice of the invention includes, but is not limited to, requiring the user to move a cursor to a prescribed location using the arrow keys, or the like. Another example of using a keyboard 140 in the practice of the invention includes requiring the user to type certain non-alphanumeric characters, such as press a particular function key, such as “F2.” An example of an instruction to touch a touch screen display that might be employed in the practice of the invention includes, but is not limited to, requiring the user to touch the screen at a prescribed location, such as to touch, e.g., with a stylus in the case of a PDA, an object blinking on a display screen 146.

In each such example of instructions presented to the user, the data processing system 120 captures the user's movement of the mouse 142, input on the keyboard 140, or touch on a touch screen, as applicable, and sends such response over the network 110 to authentication device 112, which in turn determines in Step 218, whether the user has successfully complied with the instruction in terms of accuracy and timing. For example, if the instruction presented to the user requires the user to track the movement of an object with a mouse 142, the user's accuracy in tracking the movement is determined and compared to a threshold level of compliance, with the threshold being set by the system administrator. Thus, this approach focuses on capturing a non-alphanumeric response based on an instruction displayed on a screen 146. If the user's accuracy in complying with the instruction is sufficient as determined in Step 218, the user is provided with another opportunity to enter his or her user ID and password (i.e., the user will be prompted with the logon page again), with “N” being reset to zero in Step 220. It is noted that an optional step may be included that allows only a certain number of resets of “N” before disabling logon.

If the user's accuracy in complying with the instruction is insufficient as determined in Step 218, and the user has not yet made at least M unsuccessful attempts (with “M” being set by the system administrator), the authentication server 112 presents the user with another instruction at Step 216. However, if the user has made M+1 attempts to comply with an instruction, the user will not be allowed to make another attempt at Step 216 but is instead the authentication server will disable any further logon attempts by the user at Step 224. Such disablement can be either permanent or time limited in nature, at the option of the system administrator or like decision maker in regard to the system.

In an additional option to the embodiment of the invention, it may be also determined, such as by the authentication device 112, whether a particular requester is an authorized user who is seeking authentication for access to the system, or whether instead the requester is an unauthorized requester who is using, for example, a dictionary attack or the like to improperly hack into the system. Such determination may be made programmatically based upon such factors as the number of attempted logons; the number of times a particular requester attempts to comply with the instruction provided in Step 216; and/or the level of inaccuracy (or perhaps complete lack of compliance) in performing the instruction at Step 218. If a determination is made that the requester is seeking to improperly obtain access to the system, the authentication device 112 or the like can take the further action of disabling future logon from the source of such attempts. The source can be identified using the IP address from which the request originates. Such disablement can be permanent or can be time limited, as preferred by a system administrator or other like decision maker.

For an additional measure of security, the authentication server 112 may provide the instruction to the user in Step 216 in a distorted image, rather than in plain text, thereby rendering it more difficult for a programmatic attack to decipher the instruction.

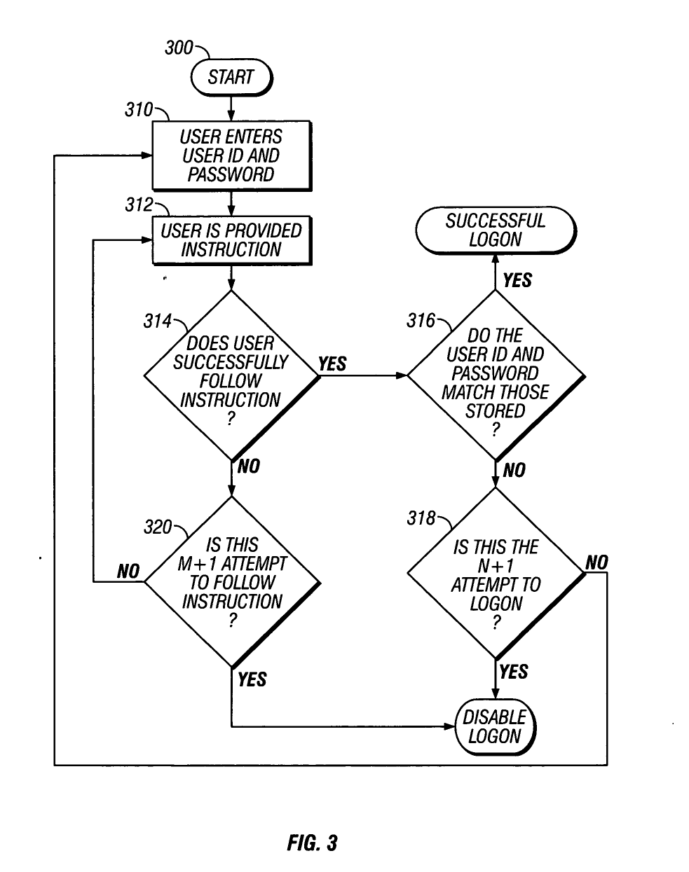

Turning to FIG. 3, an alternative embodiment of the invention is depicted in which the user's compliance with an instruction serves as an additional check to the successful entry of a user ID and password. At Step 300, the user starts the authentication process. At Step 310, the user (e.g., using the device client 116) enters a user id and password and submits the same over a communication link 138 to authentication server 112. At Step 312, the user is provided with a challenge in the form of an instruction which, like the instruction in Step 216 in FIG. 2, requires the user to submit input, at least one element of which is not alphanumeric. In Step 314, the authentication device 112 determines whether the user successfully followed the instruction, and if so, the authentication device 112, in Step 316, determines whether the user ID and password match those stored on the system. If the user ID and password submitted by the user match according to Step 316, the user is authenticated and the authentication device 112 authorizes the user's successful logon to the secure system. If the user ID and password submitted by the user do not match those stored on the system according to Step 316, the authentication server 112 will not allow the user access to the secure system but will determine, in Step 318, whether to allow the user to make another attempt to submit a user ID and password. If the user has not yet made at least N unsuccessful attempts, the authentication server 112 will allow the user to attempt to submit a user ID and password at Step 310. However, if the user has made N+1 attempts, the user will not be allowed to make another attempt at Step 210 but is instead disabled from attempting to logon.

Continuing with FIG. 3, if the user is determined by the authentication device 112 in Step 314 to have failed to follow the instruction, the authentication server 112 will then determine, in Step 320, whether to allow the user to make another attempt to follow an instruction. If the user has not yet made at least M unsuccessful attempts, the authentication device 112 will allow the user to attempt to follow a newly presented instruction at Step 312. However, if the user has made M+1 attempts, the user will not be allowed to make another attempt at Step 312 but instead is disabled from attempting to logon.

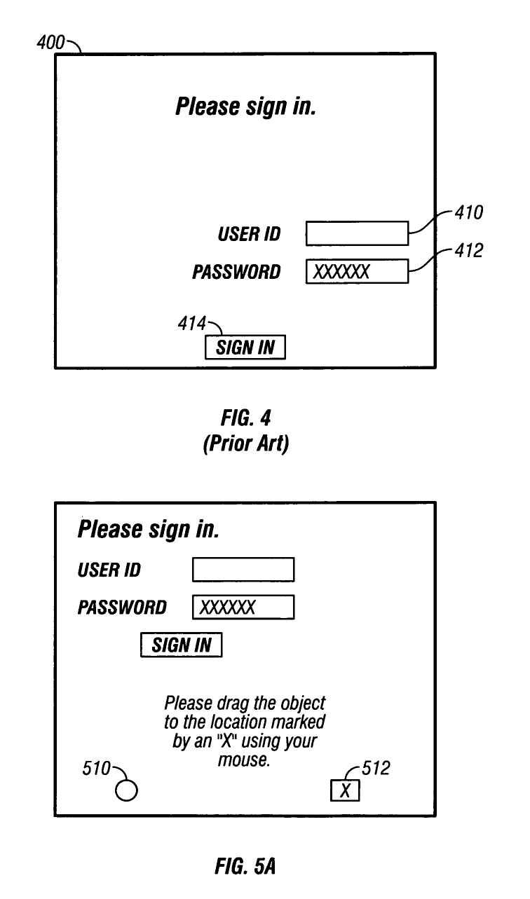

Turning to FIG. 4, a graphical illustration is presented showing the screen that may be presented to the user via display 146 for entry of a user ID and password, such as Step 210 or Step 310, as is well known in the art. If the user wishes to request access to the secure system, the user inputs his or her user ID and password at boxes 410 and 412, respectively, and then clicks or otherwise activates the “sign in” (or “login” or the like) button at 414.

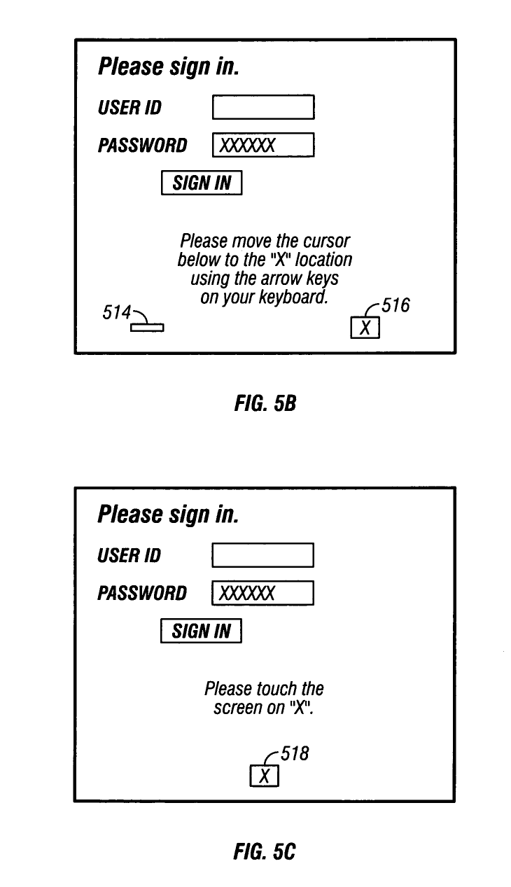

Turning to FIGS. 5A-5C, these are graphical illustrations of the screens that may be presented to the user on display 146 at Step 216 or Step 312, respectively, to provide the user with an instruction with which to comply toward authentication for access to the secure system. In one embodiment of the invention, the instruction is provided to the user in an expanded screen after completion of the user ID and password. In FIG. 5A, therein is depicted an instruction to drag an object 510 using a mouse 142 to the location 512. In FIG. 5B, therein is depicted an instruction to move a cursor 514 using arrow keys on a keyboard 140 to the location 516. In FIG. 5C, therein is depicted an instruction to touch the touch screen display at location 518. Another embodiment would be an instruction in a video game to point and “shoot” a particular target. Each of the foregoing examples is illustrative only of the types of instructions that may be presented to a user in the practice of the invention.

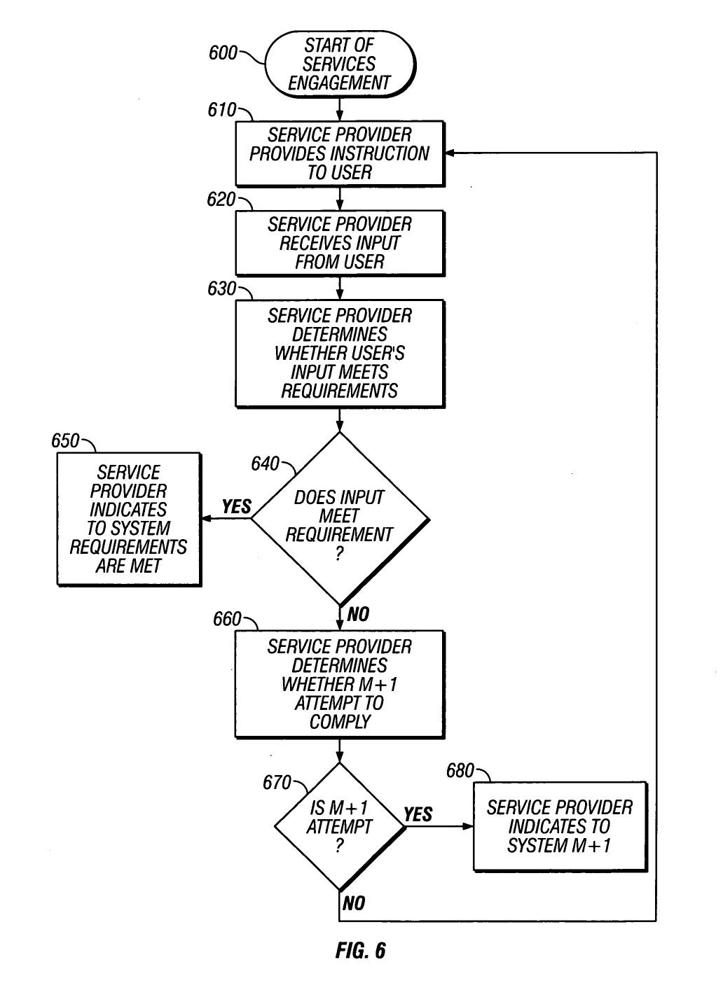

The invention may be implemented in regard to any secure system to prevent unauthorized access to that system by, for example, a hacker using programmatic guessing of user id's and passwords. A third party or “service provider” may employ the invention in order to accomplish some or all of the foregoing tasks for or on behalf of any such secure system. For these reasons, the steps depicted in FIG. 6 (described below) are indicated as being accomplished by a service provider, although the invention is not so limited and may be accomplished by a user or operator of, e.g., the authentication device 112 or any delegate or agent thereof. It is noted that the steps depicted in FIG. 6 can be performed in other orders, and that the series of steps depicted are for illustrative purposes only.

Turning to FIG. 6, therein is depicted an exemplary series of steps that a service provider in regard to an authentication device 112 might employ in the practice of the invention. In this embodiment of the practice of the invention, a service provider would perform the service of confirming that the user satisfactory responds to an instruction further to the practice of the invention. In Step 600, the service provider starts the services engagement. In Step 610 the service provider (on its own or on its behalf) provides an instruction to the user that requires the user to submit input, at least one element of which is not alphanumeric. The service provider then receives, in Step 620, input from the user in response to the instruction. In Step 630, the service provider then determines whether the input from the user successfully complies with the instruction in terms of accuracy and timing. If the user's accuracy in complying with the instruction is sufficient as determined in Step 640, the service provider indicates that the user has complied with the instruction. If the service provider determines in Step 640 that the user has not sufficiently complied with the instruction, the service provider then determines whether the user has yet made at least M unsuccessful attempts to comply (with “M” being set by the system administrator), and if not, the service provider (on its own or on its behalf) presents the user with another instruction at Step 610. However, if the user has made M+1 attempts to comply with an instruction, the service provider indicates that the user has not complied with the instruction. If the service provider provides information regarding the lack of compliance to, e.g., the authentication device 112, the authentication device may then disable further attempts to logon using that information, such as in Step 224.

The invention can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the preferred embodiments of the present invention have been illustrated in detail, the skilled artisan will appreciate that modifications and adaptations to those embodiments may be made without departing from the scope of the present invention as set forth in the following claims.

What is claimed is:

1. A method for authenticating a user over a communication medium, the method comprising the steps of:
Sending via said communication medium an instruction to the user, said instruction including at least one element in which the user is directed to provide input that is not alphanumeric;
The user preparing said input and sending said input via said communication medium in response to said instruction;
An authentication server receiving said input via said communication medium;
Said authentication server checking said input to determine whether it complies with said instruction; and
If results of said determination by said authentication server are sufficient, and said authentication server has sufficient identifying information regarding the user, sending via said communication medium an indication that the user is authenticated.

2. The method of claim 1 in which said at least one element comprises a directive to place an object at a specific position on a display screen.

3. The method of claim 1 in which said at least one element comprises a directive to track a moving object on a display screen.

4. The method of claim 1 in which the step of the user preparing said input comprises manipulating a mouse.

5. The method of claim 1 in which the step of the user preparing said input comprises typing on a keyboard.

6. The method of claim 1 in which the step of the user preparing said input comprises touching a touch screen display.

7. The method of claim 1 in which said identifying information comprises a user id and a password.

8. A computer program product on a computer readable medium usable with a programmable computer, said computer program product having computer readable program code embodied therein for authenticating a user over a communication medium, the computer program product to perform steps comprising:
Sending via said communication medium an instruction to the user, said instruction including at least one element in which the user is directed to provide input that is not alphanumeric;
Receiving said input from the user via said communication medium;
Checking said input to determine whether it complies with said instruction; and
If results of said determination are sufficient, and with sufficient identifying information regarding the user, sending via said communication medium an indication that the user is authenticated.

9. The computer program product of claim 8 in which said identifying information comprises a userid and a password.

10. The computer program product of claim 8 in which said input is provided by the user's manipulation of a mouse.

11. The computer program product of claim 8 in which said input is provided by the user's typing on a keyboard.

12. The computer program product of claim 8 in which said input is provided by the user touching a touch screen display.

13. A system for authenticating a user over a communication medium, said system comprising:
A first transmitter means to send via said communication medium an instruction to the user, said instruction including at least one element in which the user is directed to provide input that is not alphanumeric;
An authentication means to receive said input via said communication medium, to check said input to determine whether it complies with said instruction, and to check for sufficiency of identifying information provided by the user; and
A second transmitter means to send via said communication medium to the user an indication regarding whether the user is authenticated.

14. The system of claim 13 further comprising a user interface by which the user receives said instruction, prepares said input, and sends said input via said communication medium.

15. The system of claim 13 in which said identifying information comprises a user id and a password.

16. The system of claim 14 in which said user interface comprises a mouse and a display screen.

17. The system of claim 14 in which said user interface comprises a touch screen display.

18. The system of claim 14 in which said user interface comprises a keyboard and a display screen.

19. A method for providing a service of authenticating a user over a communication medium, the method comprising:
Sending via said communication medium an instruction to the user, said instruction including at least one element in which the user is directed to provide input that is not alphanumeric;
Receiving said input from a user via said communication medium;
Checking said input to determine whether it complies with said instruction; and
If results of said determination are sufficient, sending via said communication medium an indication that the user input is sufficient.

20. The method of claim 19 in which said at least one element is selected from the group consisting essentially of a directive to place an object in a specific position on a display screen and a directive to touch a specific position on a touch screen display.
